(19) United States
(12) Patent Application Publication
(10) Pub. No.: US 2025/0094857 A1
(43) Pub. Date: Mar. 20, 2025

(54) DETECTING TASK-RELATED PATTERNS USING ARTIFICIAL INTELLIGENCE TECHNIQUES

(71) Applicant: Dell Products L.P., Round Rock, TX (US)

(72) Inventors: Vadivelan Maruthamuthu, Salem (IN); Sinu Chacko, Whitefield (IN); Yamunadevi Shanmugan, Bengaluru (IN); Boya Narasimha Murthy, Bengaluru (IN); Rajendra Varma Indukuri, Rajamahendravaram (IN); Sumithra Ramamoorthy, Bangalore (IN)

(21) Appl. No.: 18/370,619

(22) Filed: Sep. 20, 2023

(51) Int. Cl. G06N 20/00

(52) U.S. Cl. CPC G06N 20/00

(57) ABSTRACT

Methods, apparatus, and processor-readable storage media for detecting task-related patterns using artificial intelligence techniques are provided herein. An example computer-implemented method includes obtaining data associated with at least one task and related to one or more task performance-related metrics; detecting one or more patterns indicative of one or more task performance issues by processing at least a portion of the obtained data using one or more artificial intelligence techniques; generating, using the one or more artificial intelligence techniques, at least one recommendation in response to at least one of the one or more detected patterns; and performing one or more automated actions based at least in part on the at least one recommendation.

### BACKGROUND

Enterprises and other groups undertaking works such as project management and software development commonly utilize conventional approaches which include providing and/or delivering consumable increments of the work over a certain period of time. However, such conventional approaches typically require periodic supervision and/or monitoring by users, which can increase work-related errors as well as resource consumption and/or resource wastage.

### SUMMARY

Illustrative embodiments of the disclosure provide techniques for detecting task-related patterns using artificial intelligence techniques.

An exemplary computer-implemented method includes obtaining data associated with at least one task and related to one or more task performance-related metrics, and detecting one or more patterns indicative of one or more task performance issues by processing at least a portion of the obtained data using one or more artificial intelligence techniques. The method also includes generating, using the one or more artificial intelligence techniques, at least one recommendation in response to at least one of the one or more detected patterns, and performing one or more automated actions based at least in part on the at least one recommendation.

Illustrative embodiments can provide significant advantages relative to conventional approaches. For example, problems associated with increases in work-related errors as well as resource consumption and/or resource wastage are overcome in one or more embodiments through detecting task-related patterns using artificial intelligence techniques and automatically generated one or more recommendations based thereon.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for detecting task-related patterns using artificial intelligence techniques in an illustrative embodiment.

FIG. 2 shows an example feedback-related workflow using agile metrics in an illustrative embodiment.

FIG. 3 shows an example feedback-related workflow using trained data metrics in an illustrative embodiment.

FIG. 4 shows an example workflow for creating one or more datasets in an illustrative embodiment.

FIG. 5 shows an example decision tree flow diagram for a burndown chart in an illustrative embodiment.

FIG. 6 is a flow diagram of a process for detecting task-related patterns using artificial intelligence techniques in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

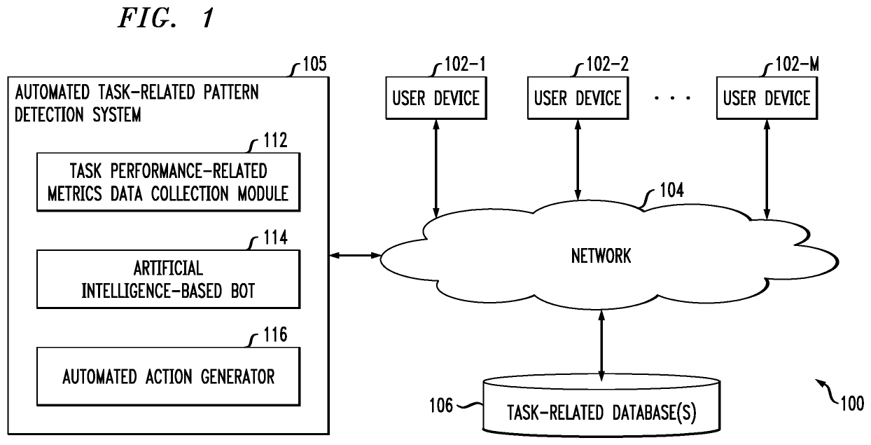

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated task-related pattern detection system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated task-related pattern detection system 105 can have one or more associated task-related databases 106 configured to store data pertaining to agile management tool-related data, metrics data (e.g., agile metrics data), feedback data, artificial intelligence-based bot-related data, team and/or user data, task-related temporal data, historical task performance data, etc.

The task-related database(s) 106 in the present embodiment is implemented using one or more storage systems associated with automated task-related pattern detection system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated task-related pattern detection system 105 are one or more input-output devices, which illustratively comprise keyboards, displays or other types of input-output devices in any combination. Such input-output devices can be used, for example, to support one or more user interfaces to automated task-related pattern detection system 105, as well as to support communication between automated task-related pattern detection system 105 and other related systems and devices not explicitly shown.

Additionally, automated task-related pattern detection system 105 in the FIG. 1 embodiment is assumed to be implemented using at least one processing device. Each such processing device generally comprises at least one processor and an associated memory, and implements one or more functional modules for controlling certain features of automated task-related pattern detection system 105.

More particularly, automated task-related pattern detection system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated task-related pattern detection system 105 to communicate over the network 104 with the user devices 102, and illustratively comprises one or more conventional transceivers.

The automated task-related pattern detection system 105 further comprises task performance-related metrics data collection module 112, artificial intelligence-based bot 114, and automated action generator 116.

It is to be appreciated that this particular arrangement of elements 112, 114 and 116 illustrated in the automated task-related pattern detection system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for detecting task-related patterns using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated task-related pattern detection system 105 and task-related database(s) 106 can be on and/or part of the same processing platform.

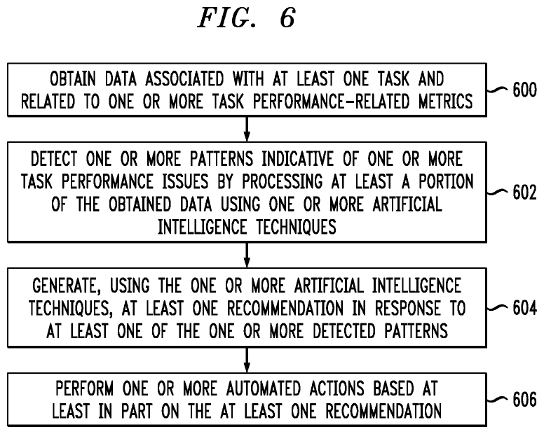

An exemplary process utilizing elements 112, 114 and 116 of an example automated task-related pattern detection system 105 in computer network 100 will be described in more detail with reference to the flow diagram of FIG. 6.

Accordingly, at least one embodiment includes detecting task-related patterns (e.g., one or more anti-patterns) using artificial intelligence techniques in connection with one or more metrics (e.g., one or more agile metrics). As used herein, an anti-pattern refers to a deviation from an expected task-related performance. As also used herein, agile metrics refer to measures of quantitative assessment used for evaluating, comparing, and/or tracking performance of related tasks. Further, as used herein, an agile team refers to a cross-functional group of people with a common goal, wherein such a group can be, e.g., flexible in the way they work and adaptable to changing requirements.

Accordingly, at least one embodiment can include, for example, detecting one or more anti-patterns in task-related data by analyzing one or more agile metrics using one or more artificial intelligence techniques, as well as generating and/or outputting one or more recommendations (e.g., possible solutions) related to the detected anti-pattern(s).

One or more embodiments can include identifying a set of agile metrics to be analyzed against one or more predetermined patterns (e.g., ideal patterns) for at least one given task to determine one or more anti-patterns that restrain productivity of at least one team (e.g., at least one agile team) working on the at least one given task. Such agile metrics can include, for example, and as further detailed herein, a burndown chart, an epic burndown report, velocity, a control chart, a cumulative flow diagram, value delivered, lead time, throughput, work item age, blocked time, escaped defects, quality intelligence, etc.

As used herein, a burndown chart refers to a graphical representation of one or more task-related items to be completed, and/or which have been completed, against a task-related timeframe. By way of further illustration, a burndown chart can be utilized in making example determinations such as the following. If a team finishes all task-related items early in the sprint, it can imply that the team's resources and/or potential is not being efficiently leveraged. As used herein, a sprint refers to a period of time (e.g., a short or limited period of time) in which a team works to complete one or more specific tasks, milestones and/or deliverables. Also, if a team misses and/or fails to complete planned sprint task-related items, it can imply that the team has overcommitted. Additionally, if a burndown chart drops steeply, it can imply task-related items are not being separated and/or itemized with sufficient granularity, while if a burndown chart is falling and rising significantly, it can imply that the team is adding task-related items throughout the sprint. Accordingly, at least one embodiment includes analyzing previous sprint burndown charts and allocating task-related items and/or resources based at least in part on such analysis.

As used herein, an epic burndown report depicts the progress of at least one team against an epic, which can include a set of tasks and/or task-related items to be completed by the at least one team. In one or more embodiments, release planning, which can include incremental releases of a product and/or portions thereof, includes balancing multiple epics (e.g., all epics) with incremental deliverables during and/or associated with each sprint. Also, in such an embodiment, at least one interrupt buffer should be maintained for scope creep during velocity planning, and while creating epics, acceptance criteria and related definitions are to be identified. As used herein, an interrupt buffer refers to a certain amount of time or capacity for handling unplanned work. Also, scope creep, as used herein, refers to changes in a planned amount of work that occur after the commitment.

As additionally used herein, velocity refers to the average amount of work a team completes during a given timeframe. Velocity planning, in one or more embodiments, can include separating tasks and/or task-related items as granularly as possible, and predicting one or more challenges and/or impediments related to completing those tasks and/or task-related items. Also, velocity planning can additionally or alternatively include forecasting team commitments based at least in part on analyzing previous team commitments and related commitment deviations. By way of illustration, if the story point is more than an individual's velocity during the sprint, then it implies that the task has more complexity and can be broken down. Additionally, in one or more embodiments, predicting challenges can be based at least in part on the historical dependency data of the tasks and the profile(s) of the team members.

A control chart, as used herein, refers to a graphical representation of status transition information for a task, task-related item, sprint, and/or release against a given duration of time. Status transition information can refer to how long a task is associated with given states, wherein status transition information can include, for example, getting started, being in progress, completion, and validated against a requirement. In one or more embodiments, a control chart can be utilized to make example determinations such as increased cycle time(s) due, e.g., to requirements changes, inconsistent cycle time(s) due, e.g., to incorrect estimates and/or unanticipated challenges and/or impediments, etc. As used herein, cycle time refers to a measure of how long it takes to complete a single task. Accordingly, such an embodiment can include analyzing data related to challenges and/or impediments for improved and/or more consistent cycle time determinations and/or estimations.

As used herein, a cumulative flow diagram refers to a visualization of one or more task-related metrics (e.g., cycle time, throughput, work in progress, etc.). In one or more embodiments, a cumulative flow diagram can be utilized to assess and/or manage task-related backlogs, removing duplicate and/or obsolete task-related items, etc. Further, value delivered, as used herein, refers to the quality of work completed (e.g., delivered to a customer) in connection with one or more tasks. In at least one embodiment, data related to value delivered (e.g., customer feedback data, task-related requirement data, etc.) can be utilized to determine and/or prioritize higher-value features of a given product and/or task.

Lead time, as used herein, refers to the total amount of time from the moment a stakeholder makes a request to the time a request-related deliverable has been output and/or provided to the stakeholder. In at least one embodiment, lead times associated with different products and/or tasks can be prioritized based, for example, on stakeholder (e.g., customer) value addition, efficient balancing of resources across multiple tasks, etc. Additionally, as used herein, throughput refers to the average number of tasks completed per given unit of time. One or more embodiments can include utilizing throughput data, in conjunction with information such as technical requirements, technical capacity, available time and resources, etc., to plan one or more tasks and/or allocate resources in accordance therewith.

As also used herein, work item age refers to the elapsed time after work has started on a given task and/or task-related item. In at least one embodiment, work item age information can be utilized to define related work at a more granular level to determine one or more related estimations on an improved basis. Further, blocked time, as used herein, refers to the amount of time that a particular task and/or task-related item is blocked (e.g., precluded from being completed). One or more embodiments can include utilizing blocked time data to identify and/or address such blockers (e.g., issues leading to completion preclusion). Accordingly, with respect to blockers or blocked time, if there are possible solutions based, for example, on historical data associated with the tasks, one or more such solutions will be suggested to the team; otherwise, one or more notifications (e.g., identifying the existence of a blocker) will be sent to the team.

Additionally, escaped defects, as used herein, refers to defects for a given release (e.g., a product) found and/or identified after the release date. Also, quality intelligence, as used herein, refers to a measure of the viability and/or quality of a release (e.g., software) as a whole unit, instead of focusing on specific points in the development process. Quality intelligence can be measured, e.g., using user feedback, escalation data, and/or the history of escaped defects of the given task or project. For example, at least one embodiment can include utilizing quality intelligence information to identify important pieces of code by analyzing customer escalations and increasing focus on improving quality with respect to those pieces of code.

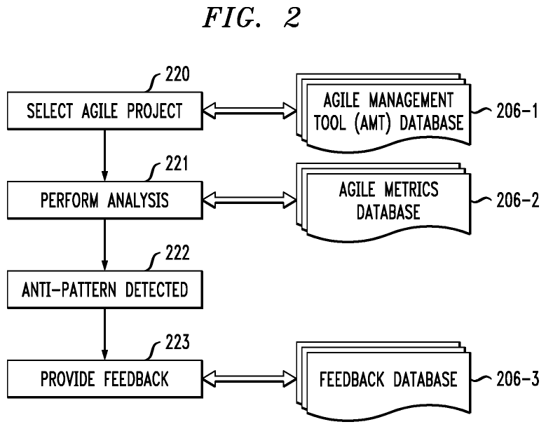

FIG. 2 shows an example feedback-related workflow using agile metrics in an illustrative embodiment. As depicted in FIG. 2, based at least in part on input (e.g., task-related metrics) from agile management tool (AMT) database 206-1, step 220 includes selecting an agile project. Based at least in part on input from agile metrics database 206-2, step 221 includes performing analysis on the selected agile project. In at least one embodiment, input from agile metrics database 206-2 includes an input dataset of important and/or relevant agile metrics that can provide insights to the given agile team on their progress and efficiency in connection with the selected agile project. In connection with the analysis performed in step 221, and for each of the inputs provided by agile metrics database 206-2, one or more anti-patterns can be detected by comparing such data against the ideal pattern(s) and determining at least one relevant recommendation based on the deviation(s) observed in step 222. Additionally, as depicted in FIG. 2, based on the detected anti-pattern(s) and input from feedback database 206-3, step 223 includes outputting and/or providing feedback, e.g., to the given agile team carrying out the selected agile project. Such feedback can include, for example, one or more suggestions for improving and/or remedying the detected anti-pattern(s) that the agile team can incorporate to improve efficiency and/or productivity. Further, in at least one embodiment, feedback database 206-3 can contains mappings of all anti-patterns and related recommendations based at least in part on the deviations observed.

As further detailed herein, one or more embodiments include implementing at least one artificial intelligence-based bot, which leverages one or more agile metrics of the given task(s) and/or project(s) to compare with one or more predetermined patterns (e.g., one or more ideal patterns) for the one or more respective metrics chosen, and facilitates identification of one or more anti-patterns at any point during the run-time of the given task(s) and/or project(s). As used herein, an artificial intelligence-based bot can include at least one artificial intelligence-based software program and/or component. Further, such an artificial intelligence-based bot as detailed above can, based at least in part on the detected anti-pattern(s) and using artificial intelligence techniques such as decision trees, unsupervised learning and/or classification algorithms, generate and/or provide suggestions and/or guidelines to one or more users (e.g., team members associated with the given task(s) and/or project(s)) related to improving and/or remedying actions associated with the detected anti-pattern(s).

In at least one embodiment, an artificial intelligence-based bot can also suggest an ideal pattern, associated with a given detected anti-pattern, to target based at least in part on the data used to train the bot. Additionally, an artificial intelligence-based bot can encompass different functionality associated with different user roles such as, e.g., a non-administrator user and an administrator. Using an artificial intelligence-based bot, a non-administrator user can, for example, select the task and/or project that the user wants to analyze based on at least one selected metric, and apply a corresponding pattern to arrive at a solution and/or suggestion to avoid an anti-pattern. Alternatively, using an artificial intelligence-based bot, an administrator can reset a task and/or project to follow a default or ideal pattern, or select a pattern from a list of available learned patterns and apply that pattern to a given task and/or project.

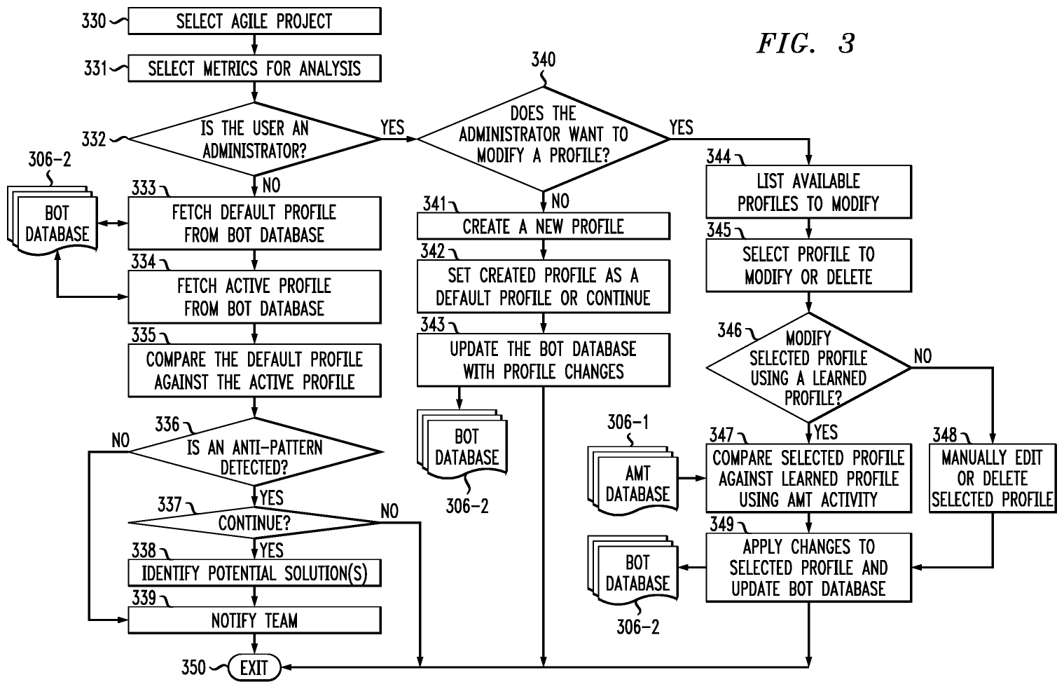

FIG. 3 shows an example feedback-related workflow using trained data metrics in an illustrative embodiment. Step 330 includes selecting an agile project to be monitored and/or analyzed, and step 331 includes selecting all metrics that need to be analyzed. In step 332, it is determined if the user is an administrator. If yes (that is, the user is an administrator), then the workflow proceeds to step 340, which includes determining if the administrator wants to modify a profile. As further detailed herein, a profile can contain information pertaining to the team that is working on the given task, including information such as skill set(s), velocity, story points being completed in a sprint, etc. If yes (that is, the administrator wants to modify a profile), the following activities are carried out: all available profiles to modify (e.g., default and custom profiles) are listed in step 344, the profile to modify or delete is selected in step 345; and a determination is made in step 346 as to whether the administrator wants to modify the selected profile using a learned profile (learned, for example, using an artificial intelligence-based bot). If yes (that is, the administrator wants to modify using a learned profile), the selected profile is compared, in step 347, against a learned profile derived from agile project data derived in AMT database 306-1, changes are applied, in step 349, to the selected profile based at least in part on the comparison, bot database 306-2 is updated accordingly, and the workflow is exited in step 350. If no (that is, the administrator does not want to modify using a learned profile), the selected profile is manually edited or deleted in step 348, changes are applied, in step 349, to the selected profile based at least in part on manual actions, bot database 306-2 is updated accordingly, and the workflow is exited in step 350.

Referring again to step 340, if no (that is, the administrator does not want to modify a profile), the following activities are carried out: a new profile (e.g., an ideal profile) is created in step 341, the profile is set as a default profile or a profile to be skipped (e.g., and not marked as a default profile) in step 342, bot database 306-2 is updated in step 343 with the profile changes, and the workflow is exited in step 350.

Referring again to step 332, if no (that is, the user is not an administrator), the following activities are carried out: a default profile is fetched from bot database 306-2 in step 333, an active profile is fetched from bot database 306-2 in step 334 to compare to the default profile, the active profile is compared against the default profile in step 335, and a determination is made in step 336 as to whether an anti-pattern is detected in connection with the comparison. If yes (that is, an anti-pattern is detected), a determination is made in step 337 as to whether the workflow needs to continue (e.g., in such an embodiment, the user can exit the workflow at multiple points, including here). If yes (that is, the workflow needs to continue), one or more potential solutions to and/or recommendations for the detected anti-pattern are identified in step 338 (e.g., using one or more decision tree techniques), the team (corresponding to the selected agile project) is notified in step 339 about the one or more solutions and/or suggestions to mitigate the detected anti-pattern; and the workflow is exited in step 350. If no (that is, the workflow needs to continue), then the workflow is exited in step 350.

Referring again to step 336, if no (that is, an anti-pattern is not detected), the team (corresponding to the selected agile project) is notified of the details in step 339, and the workflow is exited in step 350.

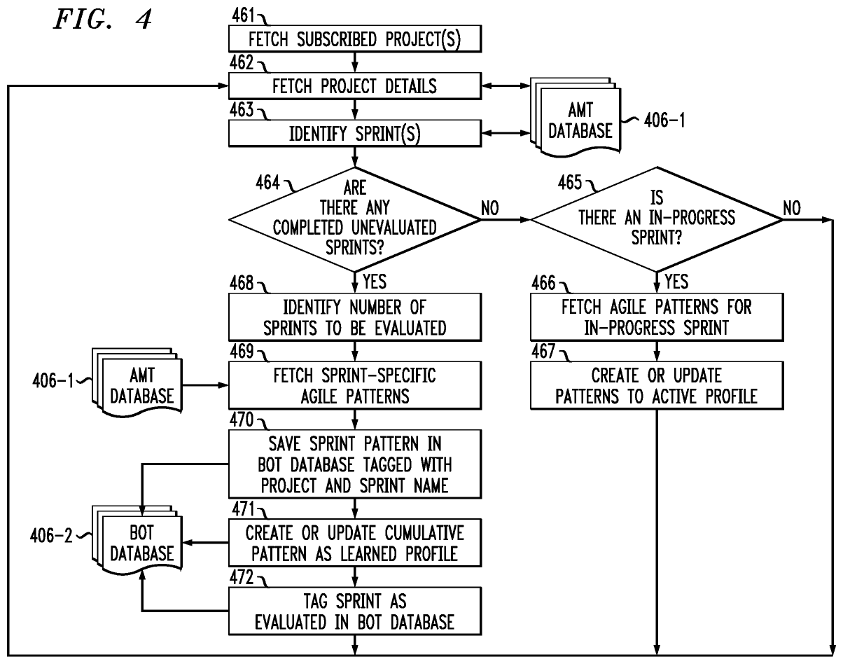

As noted herein and in connection with FIG. 4, a default profile refers to a profile for which an in-progress sprint will be evaluated (e.g., an ideal profile can be a default profile), and a default profile can be modified based at least in part on a learned profile in connection with one or more team requirements. Also, an active profile refers to a profile which holds patterns for an in-progress sprint and is used to compare against at least one default profile to check for deviations. Further, a learned profile refers to a profile which holds cumulative patterns for completed sprints for a particular task and/or project release.

FIG. 4 shows an example workflow for creating one or more datasets (e.g., sprint-wise dataset(s) and/or cumulative dataset(s)) in an illustrative embodiment. As depicted in FIG. 4, step 461 includes fetching or identifying one or more projects subscribed to and/or associated with a given artificial intelligence-based bot. Step 462 includes fetching corresponding project details from AMT database 406-1, and step 463 includes identifying data pertaining to any completed sprints from AMT database 406-1. In other words, such an embodiment includes comparing AMT data from AMT database 406-1 to bot data from bot database 406-2 to determine if such data have already been evaluated.

In step 464, a determination is made as to whether there are any completed sprints that have not been evaluated. If yes (that is, there are one or more completed sprints that have not been evaluated), the following activities are carried out: the number of sprints to be evaluated is identified and/or determined in step 468; one or more sprint-specific agile patterns are fetched, in step 469, from AMT database 406-1; each such sprint-specific agile pattern is saved, in step 470, in bot database 406-2 and tagged with the corresponding project name and sprint name; a cumulative pattern is created or updated as a learned profile in step 471, and input to bot database 406-2; and in step 472, the given sprint is tagged as evaluated in bot database 406-2. The workflow then returns to step 462, wherein project details are fetched periodically.

Referring again to step 464, if no (that is, there are no completed sprints that have not been evaluated), a determination is made in step 465 as to whether there is any sprint in progress. If yes (that is, there is a sprint in progress), one or more agile patterns for the in-progress sprint are fetched in step 466, and an active profile is created or updated in step 467 based at least in part on the fetched agile pattern(s). The workflow then returns to step 462, wherein project details are fetched periodically. If no (that is, there is a sprint in progress), then the workflow similarly returns to step 462, wherein project details are fetched periodically.

As detailed herein, one or more embodiments include integrating artificial intelligence techniques. By way merely of illustration, such an embodiment can include using a burndown chart agile metric as an example to leverage artificial intelligence techniques including, e.g., at least one supervised learning algorithm such as a decision tree. At least one artificial intelligence-based bot (e.g., an artificial intelligence-based agile metrics bot), implementing at least one supervised learning algorithm (e.g., a decision tree) can obtain and/or process burndown chart-related data from at least one source (e.g., an AMT) and validate whether at least a portion of such data matches with at least one predetermined pattern (e.g., an ideal pattern) related to the given task and/or project on a given temporal basis (e.g., on a daily basis with respect to working days). Also, in such an embodiment, at every decision level in the decision tree, one or more respective anti-patterns can be identified and tagged. Based on the particular tag, the at least one artificial intelligence-based bot can determine and/or generate at least one recommendation and/or potential solution (related to the corresponding anti-pattern), which can then be shared with at least one user and/or output to one or more additional systems to initiate one or more automated actions.

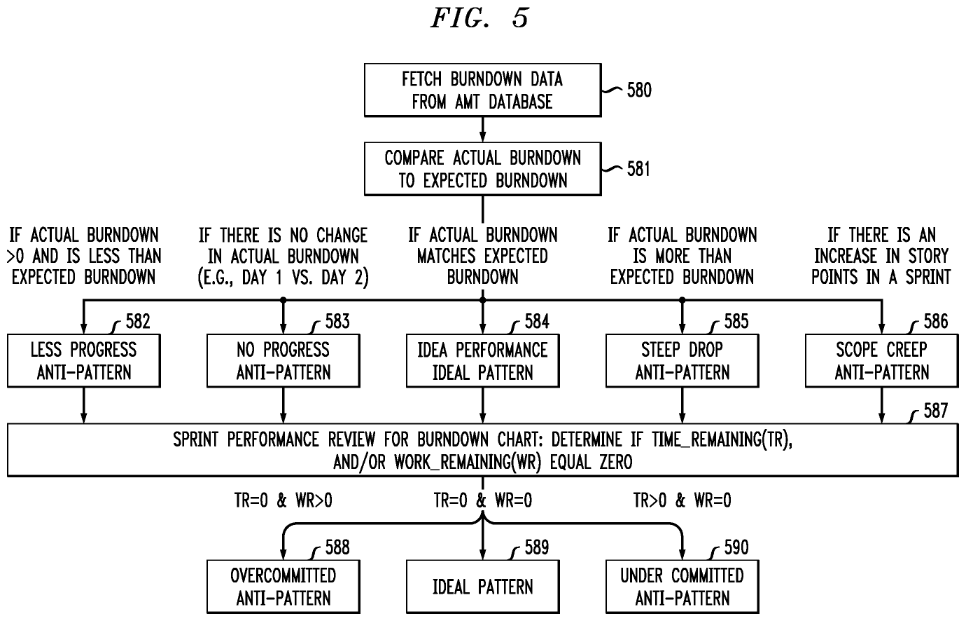

FIG. 5 shows an example decision tree flow diagram for a burndown chart in an illustrative embodiment. Specifically, FIG. 5 shows an example decision tree-based workflow carried out by at least one artificial intelligence-based bot in connection with processing burndown chart-related data (e.g., a burndown chart agile metric). Step 580 includes fetching burndown chart-related data from an AMT database, while step 581 includes comparing at least a portion of such fetched actual burndown data against expected burndown data related to the given task and/or task-related item. Based on such comparison, one or more anti-patterns and/or patterns can be detected in connection with one or more of steps 582 through 586.

For example, if the actual burndown is greater than zero and less than the expected burndown, then a less progress (than expected) anti-pattern is detected in step 582. If there is no change in the actual burndown data from a first temporal period (e.g., day 1) to a second temporal period (e.g., day 2), then a no progress anti-pattern is detected in step 583. If the actual burndown data matches the expected burndown data, then a pattern indicating ideal performance is detected in step 584. If the actual burndown is more than or greater than the expected burndown, then a steep drop anti-pattern is detected in step 585. Additionally, if there is an increase in story points in a given sprint, then a scope creep anti-pattern is detected in step 586. As used herein, story points refer to relative measures of the effort and/or complexity required to complete a task or user story (e.g., in agile software development).

Additionally, based at least in part on the anti-pattern(s) and/or pattern detected via one or more of steps 582 through 586, the at least one artificial intelligence-based bot, in step 587, can perform a sprint performance review for the actual burndown chart data. Such a performance review can be based on time remaining (TR) in the sprint and/or work remaining (WR) in the sprint becoming zero. If TR equals zero and WR is greater than zero, then an overcommitted anti-pattern is detected in step 588. If TR and WR both equal zero, then a pattern indicating ideal performance is detected in step 589. If TR is greater than zero and WR equals zero, then an under committed anti-pattern is detected in step 590.

Further, in one or more embodiments, an artificial intelligence-based bot such as detailed in connection with FIG. 5 can also map one or more detected anti-patterns to one or more recommendations and/or potential solutions, and output the same to at least one user and/or utilize the same to initiate one or more automated actions. Such mapping can be performed by the artificial intelligence-based bot based at least in part on training data and/or one or more predetermined rules. For example, a scope creep anti-pattern can be mapped to a recommendation and/or solution of identifying proper acceptance criteria during sprint planning. A no progress anti-pattern can be mapped to a recommendation and/or solution of considering at least one interrupt buffer. A steep drop anti-pattern can be mapped to a recommendation and/or solution of defining one or more related stories at a more granular level. A less progress anti-pattern can be mapped to a recommendation and/or solution of increasing granularity while breaking and/or separating stories. Additionally, an overcommitted anti-pattern and/or an under committed anti-pattern can be mapped to a recommendation and/or solution of considering one or more parameters (e.g., the weather) of a previous temporal period (e.g., a previous sprint or a prior day) while performing sprint planning.

By way of further example, at least one embodiment can include processing escaped defects data using a decision tree-based workflow carried out by at least one artificial intelligence-based bot. For instance, in connection with released versions of products (e.g., software), the at least one artificial intelligence-based bot can fetch an escaped defects count periodically and/or on a given temporal basis (e.g., every day), and process such count data to detect one or more potential anti-patterns. Such anti-patterns can include, e.g., a new Severity 1 defect, new Severity 2 defects greater than 10% of internally reported Severity 2 defects, and/or new Severity 3 defects greater than 25% of internally reported Severity 3 defects, wherein such “Severity” levels are associated with particular issues and/or events. Also, as detailed herein, in at least one embodiment, an artificial intelligence-based bot can output one or more recommendations and/or solutions in response to such escaped defect anti-patterns, wherein determining such recommendations and/or solutions can involve using one or more predetermined rules and/or one or more decision tree techniques.

Additionally, in one or more embodiments, rules can be defined (e.g., by at least one centralized technical user and/or owner) for each identified agile metric to assist in determining whether a given team is meeting expected performance parameter and/or if one or more anti-patterns are to be detected. Also, in such an embodiment at least one artificial intelligence-based bot (such as detailed above and herein) can be trained using at least a portion of these defined rules as well as data corresponding thereto, and based at least in part on such training, the at least one artificial intelligence-based bot can process input data, identify various anti-patterns, and provide corresponding recommendations and/or potential solutions. Further, feedback related to such recommendations and/or potential solutions can be used to tune and/or retrain the at least one artificial intelligence-based bot. In one or more embodiments, such tuning and/or retraining can include using such feedback to modify one or more pattern parameters and/or anti-pattern parameters for certain metrics (e.g., velocity, throughput, etc.) to be used by the bot to analyze, for example, team performance in connection with team capabilities.

FIG. 6 is a flow diagram of a process for detecting task-related patterns using artificial intelligence techniques in an illustrative embodiment. It is to be understood that this particular process is only an example, and additional or alternative processes can be carried out in other embodiments.

In this embodiment, the process includes steps 600 through 606. These steps are assumed to be performed by the automated task-related pattern detection system 105 utilizing elements 112, 114 and 116.

Step 600 includes obtaining data associated with at least one task and related to one or more task performance-related metrics. In at least one embodiment, obtaining data includes obtaining data pertaining to one or more of at least one burndown chart associated with the at least one task, at least one epic burndown report associated with the at least one task, at least one control chart associated with the at least one task, at least one cumulative flow diagram associated with the at least one task, lead time associated with the at least one task, throughput associated with the at least one task, blocked time associated with the at least one task, and one or more escaped defects associated with the at least one task.

Step 602 includes detecting one or more patterns indicative of one or more task performance issues (also referred to herein as one or more anti-patterns) by processing at least a portion of the obtained data using one or more artificial intelligence techniques. In one or more embodiments, processing at least a portion of the obtained data using one or more artificial intelligence techniques includes processing at least a portion of the obtained data using at least one supervised learning algorithm. In such an embodiment, processing at least a portion of the obtained data using at least one supervised learning algorithm can include processing at least a portion of the obtained data using at least one decision tree. Further, in such an embodiment, processing at least a portion of the obtained data using at least one decision tree can include detecting and tagging at least one pattern indicative of one or more task performance issues at each of two or more decision levels in the at least one decision tree.

Additionally or alternatively, processing at least a portion of the obtained data using one or more artificial intelligence techniques can include comparing, on a given temporal basis, the at least a portion of the obtained data against at least one predetermined pattern related to performing at least a portion of the at least one task.

Step 604 includes generating, using the one or more artificial intelligence techniques, at least one recommendation in response to at least one of the one or more detected patterns. In one or more embodiments, at least a portion of the one or more artificial intelligence techniques is trained using data associated with one or more patterns indicative of satisfactory performance of the at least one task. Additionally or alternatively, at least a portion of the one or more artificial intelligence techniques can be trained using data pertaining to at least one user associated with performing the at least one task.

Step 606 includes performing one or more automated actions based at least in part on the at least one recommendation. In at least one embodiment, performing one or more automated actions includes automatically initiating at least one operation, in connection with one or more systems associated with performing the at least one task, in furtherance of the at least one recommendation. Also, in one or more embodiments, performing one or more automated actions can include automatically outputting a description of the at least one recommendation to at least one user associated with performing the at least one task. Additionally or alternatively, performing one or more automated actions can include automatically training at least a portion of the one or more artificial intelligence techniques using feedback related to the at least one recommendation.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to detect task-related patterns using artificial intelligence techniques. These and other embodiments can effectively overcome problems associated with increases in work-related errors as well as resource consumption and/or resource wastage.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

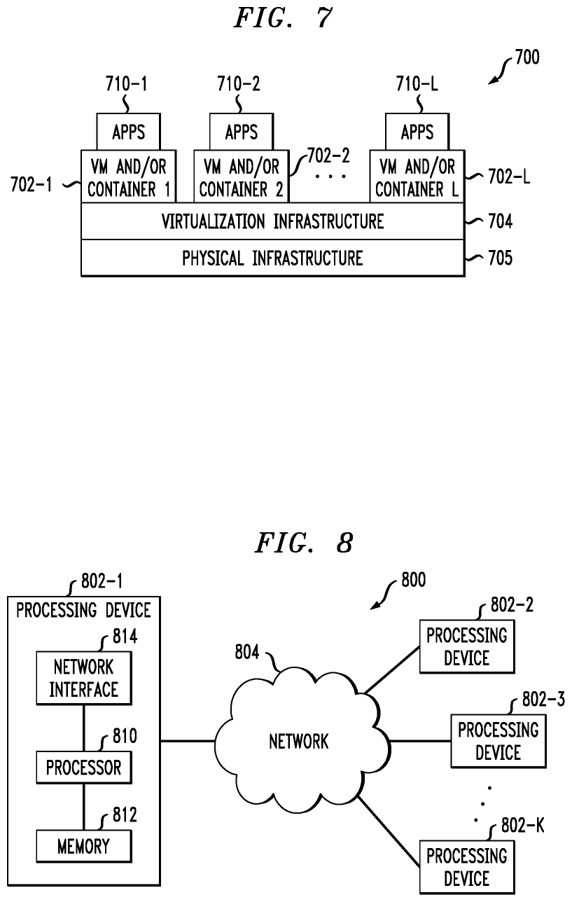

Illustrative embodiments of processing platforms will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more information processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, a CPU, a GPU, a TPU, a microcontroller, an ASIC, a FPGA or other type of processing circuitry, as well as portions or combinations of such circuitry elements.

The memory 812 comprises random access memory (RAM), read-only memory (ROM) or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data associated with at least one task and related to one or more task performance-related metrics;
detecting one or more patterns indicative of one or more task performance issues by processing at least a portion of the obtained data using one or more artificial intelligence techniques;
generating, using the one or more artificial intelligence techniques, at least one recommendation in response to at least one of the one or more detected patterns; and
performing one or more automated actions based at least in part on the at least one recommendation;
wherein the method is performed by at least one processing device comprising a processor coupled to a memory.

2. The computer-implemented method of claim 1, wherein processing at least a portion of the obtained data using one or more artificial intelligence techniques comprises processing at least a portion of the obtained data using at least one supervised learning algorithm.

3. The computer-implemented method of claim 2, wherein processing at least a portion of the obtained data using at least one supervised learning algorithm comprises processing at least a portion of the obtained data using at least one decision tree.

4. The computer-implemented method of claim 3, wherein processing at least a portion of the obtained data using at least one decision tree comprises detecting and tagging at least one pattern indicative of one or more task performance issues at each of two or more decision levels in the at least one decision tree.

5. The computer-implemented method of claim 1, wherein processing at least a portion of the obtained data using one or more artificial intelligence techniques comprises comparing, on a given temporal basis, the at least a portion of the obtained data against at least one predetermined pattern related to performing at least a portion of the at least one task.

6. The computer-implemented method of claim 1, wherein performing one or more automated actions comprises automatically initiating at least one operation, in connection with one or more systems associated with performing the at least one task, in furtherance of the at least one recommendation.

7. The computer-implemented method of claim 1, wherein performing one or more automated actions comprises automatically training at least a portion of the one or more artificial intelligence techniques using feedback related to the at least one recommendation.

8. The computer-implemented method of claim 1, wherein performing one or more automated actions comprises automatically outputting a description of the at least one recommendation to at least one user associated with performing the at least one task.

9. The computer-implemented method of claim 1, wherein at least a portion of the one or more artificial intelligence techniques is trained using data associated with one or more patterns indicative of satisfactory performance of the at least one task.

10. The computer-implemented method of claim 1, wherein at least a portion of the one or more artificial intelligence techniques is trained using data pertaining to at least one user associated with performing the at least one task.

11. The computer-implemented method of claim 1, wherein obtaining data comprises obtaining data pertaining to one or more of at least one burndown chart associated with the at least one task, at least one epic burndown report associated with the at least one task, at least one control chart associated with the at least one task, at least one cumulative flow diagram associated with the at least one task, lead time associated with the at least one task, throughput associated with the at least one task, blocked time associated with the at least one task, and one or more escaped defects associated with the at least one task.

12. A non-transitory processor-readable storage medium having stored therein program code of one or more software programs, wherein the program code when executed by at least one processing device causes the at least one processing device:
to obtain data associated with at least one task and related to one or more task performance-related metrics;
to detect one or more patterns indicative of one or more task performance issues by processing at least a portion of the obtained data using one or more artificial intelligence techniques;
to generate, using the one or more artificial intelligence techniques, at least one recommendation in response to at least one of the one or more detected patterns; and
to perform one or more automated actions based at least in part on the at least one recommendation.

13. The non-transitory processor-readable storage medium of claim 12, wherein processing at least a portion of the obtained data using one or more artificial intelligence techniques comprises processing at least a portion of the obtained data using at least one supervised learning algorithm.

14. The non-transitory processor-readable storage medium of claim 13, wherein processing at least a portion of the obtained data using at least one supervised learning algorithm comprises processing at least a portion of the obtained data using at least one decision tree.

15. The non-transitory processor-readable storage medium of claim 12, wherein processing at least a portion of the obtained data using one or more artificial intelligence techniques comprises comparing, on a given temporal basis, the at least a portion of the obtained data against at least one predetermined pattern related to performing at least a portion of the at least one task.

16. The non-transitory processor-readable storage medium of claim 12, wherein performing one or more automated actions comprises automatically initiating at least one operation, in connection with one or more systems associated with performing the at least one task, in furtherance of the at least one recommendation.

17. An apparatus comprising:
at least one processing device comprising a processor coupled to a memory;
the at least one processing device being configured:
to obtain data associated with at least one task and related to one or more task performance-related metrics;
to detect one or more patterns indicative of one or more task performance issues by processing at least a portion of the obtained data using one or more artificial intelligence techniques;
to generate, using the one or more artificial intelligence techniques, at least one recommendation in response to at least one of the one or more detected patterns; and
to perform one or more automated actions based at least in part on the at least one recommendation.

18. The apparatus of claim 17, wherein processing at least a portion of the obtained data using one or more artificial intelligence techniques comprises processing at least a portion of the obtained data using at least one supervised learning algorithm.

19. The apparatus of claim 18, wherein processing at least a portion of the obtained data using at least one supervised learning algorithm comprises processing at least a portion of the obtained data using at least one decision tree.

20. The apparatus of claim 17, wherein processing at least a portion of the obtained data using one or more artificial intelligence techniques comprises comparing, on a given temporal basis, the at least a portion of the obtained data against at least one predetermined pattern related to performing at least a portion of the at least one task.
